(19) United States
(12) Patent Application Publication
(10) Pub. No.: US 2013/0329531 A1
(43) Pub. Date: Dec. 12, 2013

(54) WALL CLOCK WITH PERPETUAL CALENDAR MECHANISM

(71) Applicant: Thanh Van Nguyen, Sacramento, CA (US)

(72) Inventor: Thanh Van Nguyen, Sacramento, CA (US)

(21) Appl. No.: 13/911,887

(22) Filed: Jun. 6, 2013

Related U.S. Application Data
(60) Provisional application No. 61/689,452, filed on Jun. 6, 2012.

(51) Int. Cl. G04B 19/20

(52) U.S. Cl. CPC G04B 19/202
USPC 368/37

(57) ABSTRACT

A wall clock with a perpetual calendar mechanism comprising an outer case, a quartz movement, a day of the week disc, a tens disc, and a units disc, a gear train for driving the discs, another gear train for driving a month indicator hand, a battery set for a clock movement, another battery set for a drive motor, a calendar cam with forty-eight interstices, the depths of the interstices are various, depending on the lengths of months spanning four years, including a leap year, and a three step cam formed on the rear surface of the units disc and a switch control assembly having a control arm which has one end thereof contacts a bottom of the interstice of the control arm, where the three step cam initiates an end-of-the-month day-correction mechanism.

### CROSS-REFERENCE TO RELATED APPLICATIONS

This application claims the benefit of U.S. Provisional application Ser. No. 61/689,452 filed on Jun. 6, 2012.

### BACKGROUND OF THE INVENTION

1. Field of the Invention

This invention relates to a wall clock with a thermometer and a perpetual calendar mechanism comprising: an outer case; a quartz movement; a temperature device; switches; two battery sets; a drive motor; a date gear train to drive a day of a week disc, a tens disc, and an units disc; a month gear train with a gear wheel and a calendar cam to drive a month indicator hand. Calendar cam has forty-eight teeth and forty-eight interstices, the depths of which depend on the length of months. Calendar cam has a leap year adjustment mechanism. A control switch assembly has a control arm portion that carries a switch and a movable pin. A three-step cam mounted on the rear surface of the units disc cooperates with the movable pin on control arm portion to switch a mechanism on that causes the units disc to correct itself at the end of every month providing an end-of-the-month day-correction mechanism. Wall clock also includes a battery replacement or low battery signal flag.

2. Description of Related Art

There are many wall clocks in the prior art, but none with a completely analog mechanism that displays and corrects the date at the end of every month, accounting for leap years, with a 4-year battery supply to yield a perpetual clock that never needs to be re-set provided batteries are changed at least every four years.

### BRIEF SUMMARY OF THE INVENTION

Wall clock with a thermometer and a perpetual calendar mechanism includes: an outer case, a clock dial having a date window, a day disc, onto which are affixed names of the day such as MO, TU, WE, TH, FR, SA, SU and the inner diameter of the day disc has a gear wheel which engages with a date gear train for driving day disc, a tens disc, onto which are affixed three consecutive sets of numbers: 0, 1, 2, and 3 and the rear surface of the tens disc has catches, cams, and a ring with notches formed therein, a units disc, onto which are affixed eleven numbers: 0, 1, 1, 2, 3, 4, 5, 6, 7, 8, 9, and a notch made into the outer side of units disc between each number, the rear surface of the units disc including a gear wheel that engages a date gear train to rotate the units disc and a three step cam, a first, second, and third movable pins. The first and second movable pins cooperate with the catches on the tens disc to drive the tens disc; and the third movable pin cooperates with the cams on the tens disc to control the units disc's rotation.

A 24-hour gear wheel, which is engaged with a 12-hour gear wheel of the quartz clock movement, has a short catch thereon; a control switch wheel has a long curved aperture, called the first aperture, and another long curved aperture, called the second aperture therein, and a notch made into the outer side of the control switch wheel. The control switch wheel is coaxially and rotatably disposed above the 24-hour gear wheel, so that the short catch of the 24-hour gear wheel appears in the first aperture. Another gear wheel called the driven wheel has teeth occupying about half of the wheel on the outer side thereof, and a short catch thereon. The driven wheel is coaxially and rotatably disposed above the control switch wheel, so as the short catch of the driven wheel appears into the second aperture. A spring is coaxially disposed between the driven wheel and the control switch wheel to connect these wheels together. A two-tooth wheel is coaxially disposed above the driven wheel and secured to this wheel, for driving the day disc. A lock ring is fixed to the top of an axle mounted to the holding disc. A switch called the first switch is mounted on the holding disc, engaging with the control switch wheel. Whenever the lever of the first switch enters into the notch on the control switch wheel, the first switch is turned ON.

Another switch called the second switch is mounted to the inner side of the outer case. The lever of the second switch is extended and formed a round end. The round end is entered into a notch on the units disc. Whenever the units disc rotates, the round end allows the units disc to rotate over and pressing down on the round end of the lever, causing the second switch to turn ON, and whenever the round end of the lever enters into the notch on the units disc, the second switch is turned OFF.

The first long curved aperture, which has a short catch of the 24-hour gear wheel therein, allows the control switch wheel to rotate, at the time, the control switch wheel is driven by the driven wheel, during the 24-hour gear rotation. The second long curved aperture, with the short catch of the driven wheel therein, allows the 24-hour gear wheel to rotate when the driven wheel stops rotating. The short catch of the driven wheel appears in the second aperture to keep the control switch wheel rotating, at the time, the control switch wheel is driven by the driven wheel, since the spring does not have enough energy to support to keep the control switch wheel to rotate to jump down the lever of the first switch.

Normally, the spring keeps the driven wheel rotating, as the control switch wheel is driven by the 24-hour gear wheel. And when the 24-hour gear wheel drives the control switch wheel some more, the driven wheel is stopped, since the first tooth of the driven wheel has engaged the date gear train, to allow the spring to force the driven wheel gearing with the gear train as the gear train stars to drive the day disc.

At per midnight, the lever of the first switch jumps into the notch on the control switch wheel, turning the first switch ON, causing the drive motor to start to drive the date gear train. Gear wheels of the gear train has a top gear wheel engaging with gear ring on the units disc that drives the units disc. While the units disc is rotating, this causes the second switch to turn ON, prior to the first switch is OFF. While the driven wheel is driven by the gear train, causing the control switch wheel to rotate, and the lever of the first switch slides in the notch of the control switch wheel, then coming up on the outer side of the control switch wheel, causes the first switch to turn OFF. The gear train continuously drives the day disc until the last tooth of the two-tooth wheel has released the gear ring on the units disc. The current day has completely appeared through the date window. A jumper, which is control by a spring, jumps into the interstice of the ring on the day disc, to keep the disc in the correct position thereof. The units disc continuously rotates until the current day of the month completely appears through the date window and the second switch is turned OFF, as the round end of the lever of the switch enters into the notch on the units disc.

As indicated above, there are two numbers 1's on the units disc. The number 1 next to 0, called the first number 1, and the other number 1, remote from the number 0, called the second number 1. Whenever the number 1 or 2 on the tens disc, and the first number 1 on the units disc appear through the date window at the same time (corresponding to days 11 and 21), the second number 1 on the units disc will rotate past the date window. While the units disc is rotating, one end of the third pin on the units disc slides over the outer side of the cam on the tens disc, causing the other end of the pin actuating a switch called the third switch to turn ON, allowing the units disc continuously to rotate to pass the second number 1. The third movable pin is free moving within the limit thereof. To avoid the third pin unexpectedly contacts the third switch, a bump is mounted to inner side of the outer case and located before the third switch, so as, the end of the third pin always passes the bump, before the other end of the pin slides over the outer side of the cam on the tens disc. Whenever the number 0, 1, or 2 on the tens disc and the number 9 on the units disc appear through the date window at the same time (corresponding to days 09, 19, 29), the tens disc will be driven. While the units disc is rotating, one end of the first movable pin on the units disc slides over the side of a long cam which is attached to the inner side of the ring mounted inner side of the outer case, causing the other end of the pin engages with the catch on the tens disc, and drives the tens disc to the next units. The first movable pin is released after the pin has passed the long cam, before the units disc stops rotating. A jumper, which controlled by a spring, jumps into the notch on the tens disc to keep the tens disc in the correct position thereof.

Whenever the number 3 on the tens disc and first number 1 on the units disc appear through the date window at the same time (corresponding to day 31), the tens disc will be driven. While the units disc is rotating, one end of the second movable pin on the units disc slides over the side of the long cam, causing the other end of the pin to engage with the catch on the tens disc, and drives the tens disc to the next unit. The second pin is released alter the pin has passed the long cam.

A calendar cam is formed of forty-eight teeth and forty-eight interstices on the outer side of the cam. The depths of the interstices are various, each corresponding to the respective number of days within each month over a period of four years, including a leap year. The shortest depths of the interstices called the first depths for controlling the corrections of the ends of the months having 28 days; the next deeper interstice, called the second depth for controlling the month having 29 days; the next deeper interstice, called the third depths for controlling the months having 30 days; and the deepest interstices, called the fourth depths for controlling the months having 31 days.

The calendar cam is rotatably disposed above the bottom of the outer case; an inner side of the cam is rotatably fitted to the outer side of the circular wall mounted to the bottom of the outer case; a ring is disposed above the inner side of the cam; a cover disc is disposed above the ring, so as the top side of the ring rotatably engages the rear side of the cover disc to keeps the calendar cam is rotatable in the position thereof. The cover disc is secured to long nuts mounted to the bottom of the outer case.

A cam drive assembly has a control drive portion. One end of the control drive portion is rotatably mounted to a post mounted to the bottom of the outer case by a two step bolt. This end of the control drive portion is extended and forms a finger. The finger cooperates with a long catch mounted on the underside of a control disc to rotate the control drive portion to move a cam driver for rotating the calendar cam.

Between the control drive portion and the cam driver are a connector arm and a bell crank. The bell crank is rotatably mounted to a post mounted to the bottom of the outer case, with a spring thereon. This spring helps the bell crank to return to its original position, after completing a cam drive operation. The connector arm has one end rotatably connected to the remaining end of the control drive portion by a rivet. The other end of the connector arm is rotatably connected to one end of the bell crank by another rivet. The cam driver has one end that is rotatably connected to the remaining end of the bell crank by another rivet. A small spring is connected to both of the cam driver and the bell crank together, to force the other end of the cam driver to engage the teeth of the calendar cam.

A control switch assembly has a control arm portion carrying a switch called the fourth switch and a movable pin thereon. The control arm portion includes a pair of brackets to support the movable pin. The movable pin includes a round collar which is movably mounted to engage the fourth switch, and between the pair of brackets, so as whenever the pin slides, it causes the fourth switch to switch ON or OFF. A small wheel, which is mounted to top of the movable pin, cooperates with the three step cam on the units disc to control the fourth switch. The small wheel also keeps a coil spring. The coil spring helps the movable pin return to the original position after the three step cam has passed the small wheel on the movable pin.

The control arm portion having one end is coaxially, rotatably and respectively mounted above the end of the control drive portion. A two step screw is inserted through a hole on the end of the control arm portion and driven into a threaded hole on the top end of the two step bolt to rotatably secured the control arm portion and the two step bolt together.

The end of the control arm portion is extended and forms a finger. The finger engages the long cam mounted underside of the control disc, at the end of each month, to rotate the control arm portion, lifting the other end of the control arm portion out of the interstice of the calendar cam, allowing the cam is rotated by the cam driver. A spring is connected to the control arm portion, to keep the end of the control arm portion to move back and engages with the next bottom of the interstice. The control disc is driven by the day gear train and makes one revolution per month.

The end-of-the-month day-correction mechanism of the units disc causes the units disc to rotate up to three additional display numbers each month. To avoid a wrong date display, a switch called the fifth switch is arranged to cooperate with the long cam on the control disc to actuate the fifth switch ON, to connect an electrical circuit line. The electrical circuit line is connected from the fourth switch to fifth switch and then to the drive motor. Normally, the fifth switch is OFF and the electrical circuit line is disconnected. The fifth switch is ON only the last four days of per month, when the long cam on the control disc is pressing on the lever of the fifth switch, and the electrical circuit line is connected, allowing the units disc to continuously rotate to the correct last day of the month, as the fourth switch is ON.

Corrections to the date at the end of the month are as follows. If the current month has 31 days: no correction in the day of the month displayed will be done. Since, the end of the control arm portion engages the bottom of the interstice of the calendar cam for the month having 31 days. This means, the end of the control arm portion engages to the bottom of the deepest interstice of the cam, so the three step cam on the units disc will freely passes the small wheel on the top end of the movable pin without an actuation on the fourth switch.

If the current month has 30 days: the end of the control arm portion will engage with the bottom of the interstice of the calendar cam, for the month having 30 days. This means the end of control arm portion will be raised higher one step. Thus, while the units disc is rotating to pass the 30th day of the month, and before the units disc were stopped at the 31st day of the month, the first step of the three step cam, on the units disc will impinge upon the small wheel of the movable pin, causing the fourth switch to turn ON. Since the fifth switch is already in an ON position, the units disc continuously rotates and keeps the second switch ON, then the fourth switch turns OFF, as the three step cam has passed the small wheel of the pin. The units disc continuously rotates to indicate the first day of the next month, and the second switch turns OFF.

If the current month has 29 days, the end of the control arm portion will be engaged with the bottom of the interstice of the calendar cam, for the month having 29 days. This mean the control arm portion is raised higher one more step. Thus, while the units disc is rotating to pass the 29th day of the month, and before the units disc were stopped at the 30th day of the month, the second step of the three step cam will impinge upon the small wheel of the pin, causing the fourth switch to turn ON, allowing the units disc continuously to rotate to pass the 30th and 31st days of the month to indicate the first day of the next month.

If the current month has 28 days, the end of the control arm portion will be higher one more step. This mean, the end of the control arm portion will be engaged with the shallowest interstice of the cam. Thus, while the units disc is rotating to pass the 28th day of the month, and before the units disc were stopped at the 29th day, the third step of the three step cam will impinge upon the small wheel, causing the fourth switch to turn ON, allowing the units disc to rotate to pass the 29th, 30th, and 31st days, to indicate the first day of the month.

While the units disc is rotating to pass the 31st day of the month, and after the three step cam has passed the small wheel on the movable pin, the long cam on the control disc will engage to force the finger of the control arm portion, to raise the other end of the control arm portion out of the current interstice of the calendar cam, then the long cam engages the finger of the control drive portion to advance the calendar cam. When the cam begins to rotate, the first gear wheel of the gear train for driving the month indicator hand, which is engaged with the gear wheel of the calendar cam, starts to rotate, as well. After the calendar cam is advanced one tooth, the month indicator hand is also advanced, indicating the current month. A jumper jumps into the interstice of the calendar cam to keep the cam in correct position. Another jumper jumps into the interstice of the last gear of the month gear train, to keep the month indicator hand in correct position.

After the long cam on the control disc has passed the fingers of the control arm portion and the control drive portion, the end of the control arm portion returns to its normal position, engaging the bottom of the next interstice of the calendar cam corresponding to the next month. The control drive portion also returns to its original position. The clock of this invention is operated by two battery sets that need to be replaced every four years. This is the time for calendar cam to make one complete revolution.

The front surface of the calendar cam includes a pair of brushes mounted thereon. These brushes provide electrical contact with a first and second pair of copper lines mounted on the rear surface of the cover disc. The first pair has one continuous connection to one terminal of quartz clock movement and the another divided into four segments. Each segment is connected to a respective battery. The brush interconnects a respective line with one of the segments, to power the quartz clock movement for a year. The contact brush come into contact with the next segment as the cam rotated. This process continues until four years have passed.

The second pair of lines has a continuous connection to one terminal of the drive motor and the other is divided into eight segments, each segment is connected to a respective battery. The remaining brush interconnects a respective line with one of the segments, to power the drive motor for six months. The process continues as the cam rotates through one revolution, and the batteries are ready to be replaced.

The indicated time may be adjusted by adjusting a stem wheel on the back of the clock.

The indicated day and date may be adjusted by one day by pushing the wheel connector bar, causing a gear wheel to engage the date gear train and a gear to engage the gear wheel of the day disc. The wheel connector bar is locked in place by an auto lock, then a switch called the sixth switch is manually turned ON to cause the units disc to rotate. Two seconds later, the sixth switch is manually turned OFF, with the second switch is ON. The second switch is automatically turned OFF, when the day and date completely appear through the date window. The auto lock is then manually released.

In the event that, the day and date indicated on the clock need to be adjusted by more than one day. The wheel connector bar is pushed, causing a gear wheel to engage the date gear train and a gear to engage the wheel of the day disc. The wheel connector bar is locked in place by the auto lock. The sixth switch is manually turned ON, causing the units disc and the day disc to rotate. These discs continuously rotate until the current day has completely appeared through the date window when the wheel connector bar is manually released. The units disc continuously rotates, until the current day of the month begins to appear through the date window when the sixth switch is manually turned OFF. The units disc continuously rotates until the second switch is automatically turned OFF at the point when the current date has appeared through the date window.

If the indicated month and year need adjustment, the wheel connector bar is manually pulled out temporarily to lift the other end of the control arm portion out of the interstice of the calendar cam and the wheel connector bar is locked in place by an auto lock. Accessing the rear face of the clock, a sharp tool is inserted through a cam slot, into one of the holes in the calendar cam. The calendar cam is manually driven clockwise, until the current month and year appear through the windows made through the bottom of the outer case, then the auto lock is manually released.

### BRIEF DESCRIPTION OF THE DRAWINGS

FIG. 1 is a cutaway front elevation view of wall clock with clock dial, day disc, tens disc, and units discs truncated to show the interior mechanisms of wall clock.

FIG. 2 is a front elevation view of wall clock.

FIG. 3 is front elevation view of wall clock without clock dial to show the front surfaces of day disc, tens disc, and units disc.

FIG. 4 is a front elevation view of wall clock without clock dial, day disc, tens disc, and units discs depicting the perpetual calendar mechanism.

FIG. 5 is an exploded view of day disc, tens disc, and units disc.

FIG. 6 is a front elevation view of clock dial.

FIG. 7 is a cutaway rear elevation view of units disc.

FIG. 8 is a rear perspective view of tens disc.

FIG. 9 is a rear perspective view of day disc.

FIG. 10 is a rear elevation view of units disc.

FIG. 11 is a partial rear elevation view of tens disc installed within units disc to show first, second, and third movable pins on units disc, and first and second catches and cams on tens disc.

FIG. 12 is a pseudo cross sectional view of first movable pin on the units disc taken along its longitudinal center with first movable pin in a non-actuating position, depicting spatially how first movable pin clears first and second catches on tens disc and all cams on tens disc as the two discs are rotated relative to each other.

FIG. 13 is a pseudo cross sectional view of first movable pin on the units disc taken along its longitudinal center with first movable pin in an actuating position, depicting spatially how first movable pin: engages first catch on the tens disc, clears the second catch on the tens disc, and clears all cams on the tens disc as the two discs are rotated relative to each other.

FIG. 14 is a pseudo cross sectional view of second movable pin on the units disc taken along its longitudinal center with second movable pin in an actuating position, depicting spatially how second movable pin: clears first catch on the tens disc, engages the second catch on the tens disc, and clears all cams on the tens disc as the two discs are rotated relative to each other.

FIG. 15 is a pseudo cross sectional view of third movable pin on the units disc taken along its longitudinal center with third movable pin in an actuating position, depicting spatially how third movable pin clears first and second catches on tens disc, but engages a cam on tens disc to cause contact with a second switch mounted on the outer case as the two discs are rotated relative to each other.

FIGS. 16-18 are enlarged top plan views of wall clock without clock dial depicting day disc gear train with 24-hour gear wheel, where FIGS. 16-18 respectively show the progression of 24-hour gear wheel rotating and thereby driving the rotation of day disc.

FIG. 19 is an exploded perspective view of the first drive assembly.

FIG. 19A is another exploded view of first drive assembly.

FIG. 19B is a top plan view of first drive assembly.

FIG. 19C is a cross-sectional view of first drive assembly taken along the center bisection of first drive assembly.

FIG. 19D is a top plan view of first drive assembly at a time of about 11:00 PM when post 75 of the driven wheel assembly engages the front end of curve slot 82 and the first tooth of driven wheel 69 engages the gear wheel 62 of the gear train 56 and stops rotating while post 85 of 24-hour gear wheel 72 is still engaged with the rear end of aperture 81 and continues to drive the control switch disc 71.

FIG. 19E a top plan view of first drive assembly at a time of midnight when the short post 75 of the driven wheel 69 engages the rear end of curve slot 82, spring 70 is compressed, post 85 still engages the rear end of aperture 81, and the level of the first switch 47 has just entered into notch 80 of control switch disc 71, causing drive motor 46 to start to the teeth of the two-tooth wheel to engage the teeth on the day of the week disc driving it to the next day.

FIG. 19F a top plan view of first drive assembly just after midnight where post 75 of wheel 69 is engages the first end of the slot 82, the last tooth of the driven wheel 69 is released from gear train 56, spring 70 is at its original position, the level of first switch 47 is moved out of the notch 80, and post 85 is now engages the rear end of the aperture 81.

FIG. 19G a top plan view of first drive assembly at a time of about 1:00 AM where post 85 of the 24-hour gear wheel 72 engages the front end of the aperture 81 and drives the control switch disc 71 and the driven wheel 69, ready for changing the date day at the next midnight.

FIG. 20 is an exploded perspective view of the second drive assembly.

FIG. 21 is a rear elevation view of calendar cam.

FIG. 22 is front elevation view of calendar cam.

FIG. 23 is a rear elevation view of cam cover disc.

FIG. 24 is an exploded perspective view of a battery holder, a negative battery connector spring, and a AA battery.

FIG. 25 is an exploded perspective view of retainer ring and clock ring.

FIG. 26 is a cross sectional view of assembled wall clock taken along the center bisection of wall clock.

FIG. 27 is an enlarged cutaway front elevation view of wall clock depicting the gear train for month indicator hand with first and last gears.

FIG. 28 is an enlarged cutaway front elevation view of wall clock depicting the first gear of the gear train for month indicator hand engaging a tooth on calendar cam.

FIG. 29 is a rear perspective view of control disc.

FIG. 30 is a front elevation view of control disc.

FIG. 31 is an exploded enlarged perspective view of control arm portion.

FIG. 32 is perspective view of control arm portion.

FIG. 33 is an enlarged view of the cam drive assembly mounted on wall clock.

FIG. 34 is an enlarged view of control switch assembly mounted on wall clock, with control arm portion in the lower position.

FIG. 35 is an enlarged view of control switch assembly mounted on wall clock, with control arm portion in the upper position.

FIG. 36 is perspective view of control switch assembly mounted on wall clock.

FIG. 37 is an enlarged cutaway view of day disc gear train at a point when the day disc gear train is released.

FIG. 38 is an enlarged cutaway view of day disc gear train at a point when the wheel connector bar is pushed, the second drive wheel engages the gear train, and the wheel connector bar is locked by the auto lock mechanism.

FIG. 39 is an enlarged cutaway view of day disc gear train with the control bar pulled out, the control arm portion is lifted to move the end of the control arm portion out of an interstice of the calendar cam, and the control bar is locked by the auto lock mechanism.

FIG. 40 is an enlarged cutaway view of the auto lock mechanism.

FIG. 41 is an enlarged view of the outer side of wall clock depicting the exposed ends of bars and switches.

FIG. 42 is an enlarged cutaway view depicting the three step cam on the units disc as it passes the small wheel on the top of a movable pin without actuating the fourth switch.

FIG. 43 is an enlarged cutaway view depicting the first step of the three step cam on the units disc as it is about to press on the small wheel to turn the fourth switch ON.

FIG. 44 is an enlarged cutaway view depicting the second step of the three step cam on the units disc as it is about to press on the small wheel to turn the fourth switch ON.

FIG. 45 is an enlarged cutaway view depicting the third step of the three step cam on the units disc as it is about to press on the small wheel to turn the fourth switch ON.

FIG. 46 is a rear elevation view of wall clock with a battery house cover removed.

FIG. 47 is a blow-up view of battery house depicting the battery negative connectors.

FIG. 48 is a blow-up view of low battery signal device.

FIG. 49 is a pseudo cross sectional view depicting how the low battery signal device is controlled by the calendar cam.

FIG. 50 is a circuit diagram or electrical schematic diagram of wall clock.

FIG. 51 is a front elevation view of wall clock with square face with the clock dial removed.

FIG. 52 is a front elevation view of wall clock with square face.

### DETAILED DESCRIPTION OF THE INVENTION

The clock of this invention is seen in whole or in part in all of the figures. Wall clock 10 comprises an outer case 22 that is a rigid cylindrical-shaped, cuboid-shaped or rectangular cuboid-shaped member with one closed end and one open end. A ring 35 exists on the inner diameter of the open end. A first circular wall 36 and second circular wall 37 exists on the inner surface of the closed end of cylindrical-shaped member. Circular walls protrude at a right angle from the inner surface of the closed end of cylindrical-shaped member, where each circular wall is concentric with the center longitudinal axis of cylindrical-shaped member.

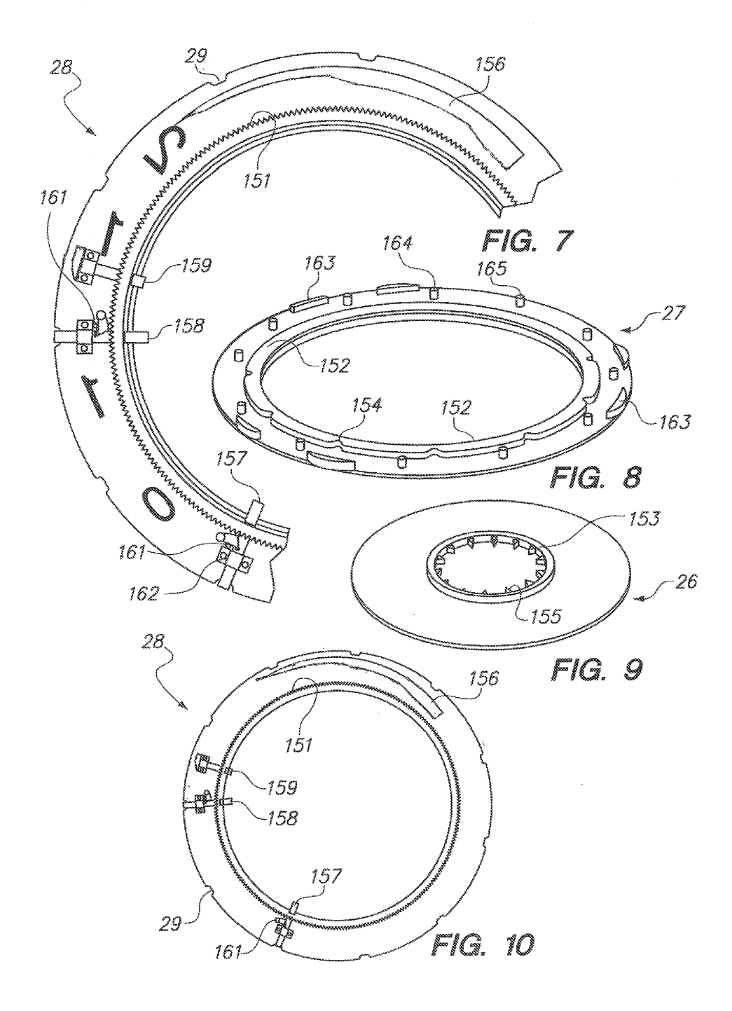

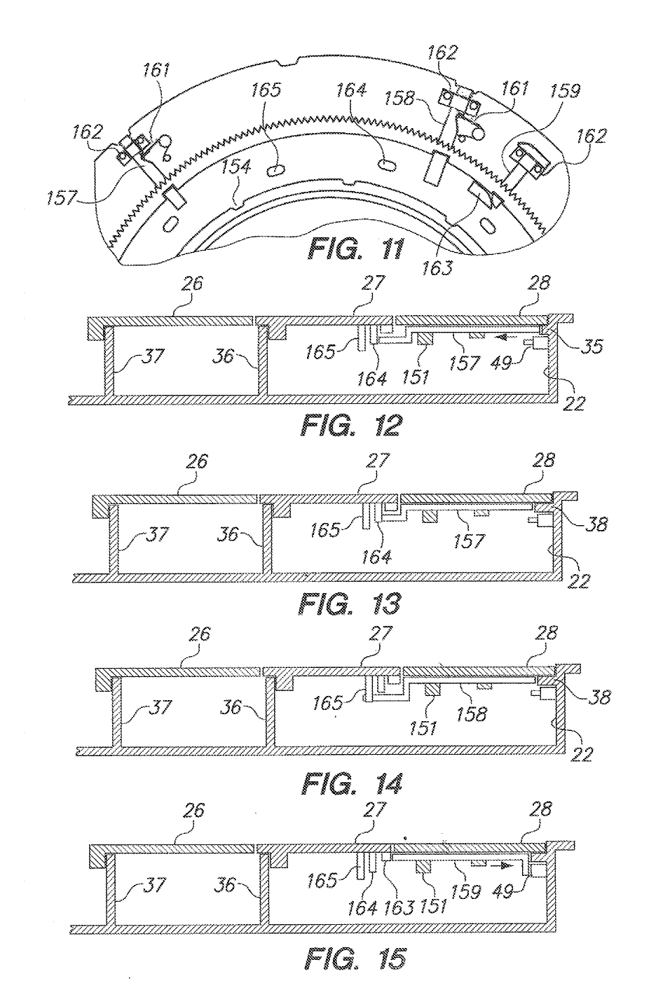

Wall clock 10 further comprises a day disc 26, a tens disc 27, and a units disc 28. Discs 26, 27 and 28 are each rigid disc-shaped members with a hole in the center. Day disc 26 has a ring 153 on its rear surface as seen in FIG. 9. Day disc 26 is rotatably disposed above the circular wall 37, so that the outer diameter of ring 153 forms a slip fit with the inner diameter of circular wall 37. Tens disc 27 has a ring 152 on its rear surface as seen in FIG. 8. Tens disc 27 is rotatably disposed above the circular wall 36, so that the inner diameter of ring 152 forms a slip fit with the outer diameter of the circular wall 36. Units disc 28 has a rear surface as seen in FIGS. 7 and 10. Units disc 28 is rotateably disposed above ring 35 and with certain rotatable engagements with the front surface of outer case 22.

The front surface of day disc 26 has a visual depiction of the seven days of the week, such as MO, TU, WE, TH, FR, SA, and SU, equally spaced around the full outer circumference of the disc. Seven small bumps 23 exist on the front surface of day disc 26, one placed between each visual depiction of a day of the week, so that they are equally spaced around the full outer circumference of the disc.

The front surface of tens disc 27 has a visual depiction of three sets of the number sequence 0, 1, 2, 3 equally spaced around the full outer circumference of the disc. Twelve small bumps 24 exist on the front surface of tens disc 27, one placed between each number, so that they are equally spaced around the full outer circumference of the disc.

The front surface of units disc 28 has a visual depiction of the number sequence 0, 1, 1, 2, 3, 4, 5, 6, 7, 8, 9 equally spaced around the full outer circumference of the disc. Eleven small bumps 25 exist on the front surface of units disc 28, one placed between each number, so that they are equally spaced around the full outer circumference of the disc

Spacer bumps 23, 24, and 25 are provided to prevent the entire surfaces of discs 26, 27, and 28 from contacting the rear surface of clock dial 13 and allow the discs to rotate easier with less friction.

Wall clock 10 further comprises a clock dial 13. Clock dial 13 is a rigid disc-shaped member with a date window 14, a temperature hole 73, a month hole 74, and screw holes 20. Clock dial 13 further comprises a temperature scale depiction 15 on its front surface. Wall clock 10 further comprises a temperature hand 17. Clock dial 13 further comprises a month scale depiction 16 on its front surface. Wall clock 10 further comprises a month indicator hand 18. Clock dial 13 further comprises an hour scale depiction 12 on its front surface. Wall clock 10 further comprises a second hand, a minute hand, and an hour hand. Hands are rigid oblong members with one end attached to a drive mechanism and the other end referencing a point on the respective scale depictions. All scale depictions are on the front surface of the clock dial 13, which is disposed above a flange 34 on outer case 22, so as screw holes 20 on the clock dial 13 fit with holes 130 made into the flange 34 of the outer case 22.

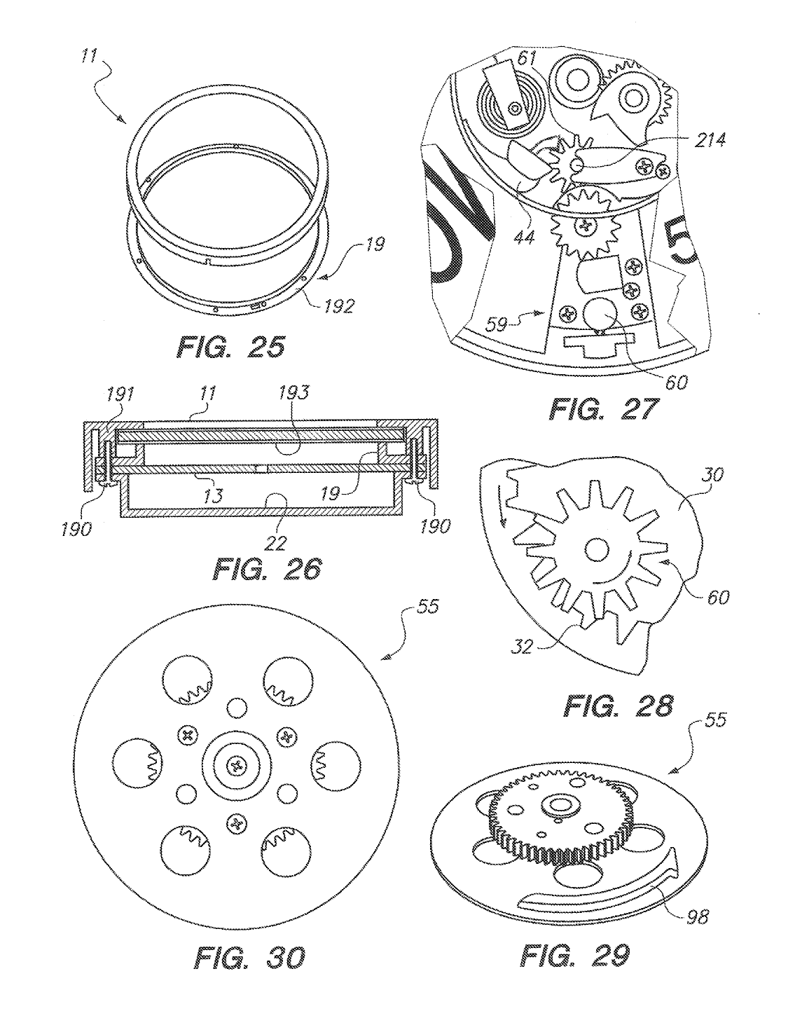

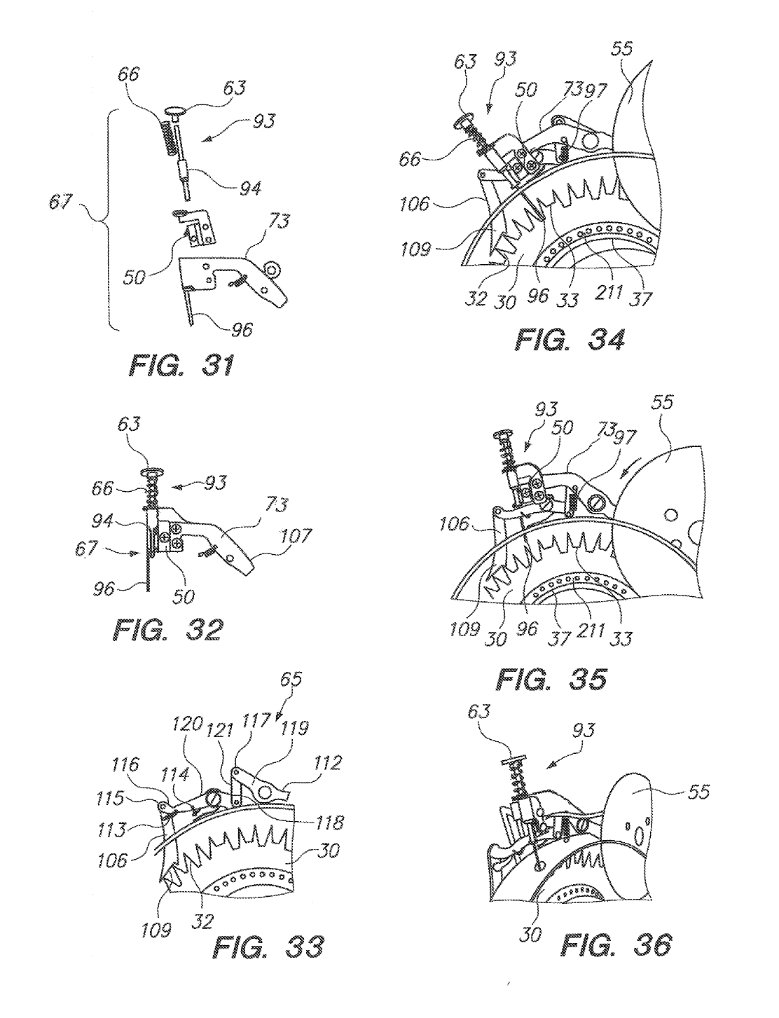

Wall clock 10 further comprises a retainer ring 19 and a clock cover ring 11 as seen in FIGS. 25 and 26. Retainer ring 19 has holes 192. Clock cover ring 11 has nut members 191. Retainer ring 19 is disposed above the clock dial 13, so as holes 192 align with screw holes 20 on the clock dial 13. Wall clock 10 further comprises a clock cover disc 193 made of glass or clear plastic which is disposed above the retainer ring 19. Clock cover ring 11 with nut members 191 is disposed above the clock cover disc 193, so that the inner diameter of clock cover ring 11 engages with the front surface of clock cover disc 193 and nut members 191 engage screws 190 inserted through holes 130 on flange 34 of outer case 22, screw holes 20 on the clock dial 13, and holes 192 on the retainer ring 19, to secure the clock cover disc 193.

FIGS. 7-10 show the rear surfaces of day disc 26, tens disc 27, and units disc 28. The rear surface of day disc 26 includes the ring 153. Ring 153 is a specially shaped ridge or raised surface in the rear surface of day disc 26. The inner diameter of ring 153 includes teeth protruding therefrom to from a gear ring 155. Gear ring 155 functions to drive the day disc 26.

The rear surface of tens disc 27 includes first catches 164, second catches 165, cams 163, and a ring 152. Ring 152 is a specially shaped ridge or raised surface in the rear surface of tens disc 27. The outer diameter of ring 152 includes notches 154.

The rear surface of unit disc 28 includes a gear ring 151 for driving the units disc 28, a three step cam 156, a first movable pin 157, a second movable pin 158, and a third movable pin 159. Notches 29 exist on the outer diameter of units disc 28. Notches 29 functions to control the rotation of units disc 28.

Three step cam 156 is a raised area on the rear surface of units disc 28. The raised area is in the form of three steps with rounded increments between each step so that a wheel could pass onto the raised area and transition between the three steps rolling smoothly without getting hung up on any corners between the three steps. Three step cam 156 is depicted in FIG. 7.

First movable pin 157 is movably mounted between the numbers 0 and 9 on the units disc 28, (seen in from front surface) by a clamp 162 and inserted through a hole in the gear ring 151 on units disc 28. A spring 161 is mounted and arranged to press first movable pin 157 radially outwardly to the outer diameter of units disc 28. Second movable pin 158 is movably mounted between the two 1's on units disc 28 (seen in from front surface), by another clamp 162 and inserted through a hole in the gear ring 151 on units disc 28. Spring 161 is mounted and arranged to press the second movable pin 158 radially outwardly to the outer side of the diameter of disc 28 to the limit of moving thereof. Third movable pin 159 is movably mounted close to the right side of the second movable pin 158, by another clamp 162 and inserted through a hole on the gear ring 151. Third movable pin 159 is a free to move outwardly or inwardly as engaged by other structure.

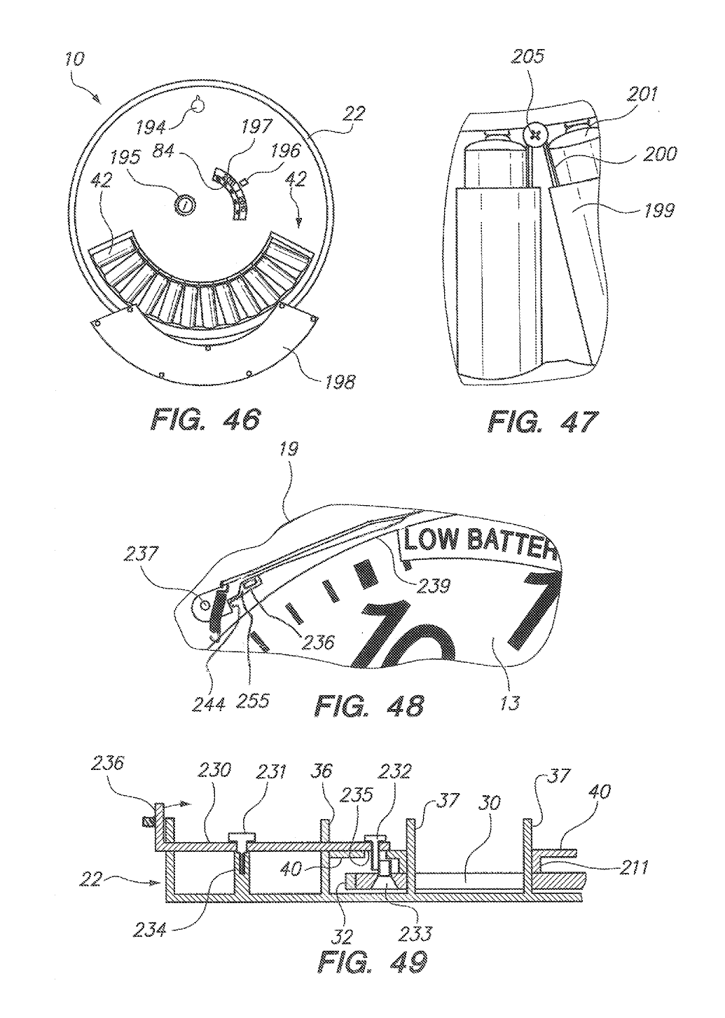

Wall clock 10 further comprises a quartz clock movement positioned inside circular wall 37, and engaged with inner surface of the closed end of cylindrical-shaped member of outer case 22. Quartz clock movement has an hour adjusting stem wheel 195, depicted in FIG. 46, which is rotatably fixed in a hole in the closed end of cylindrical-shaped member of the outer case 22. Quartz clock movement has rotating drive shafts or pins that are attached to first and second drive assemblies.

Wall clock 10 further comprises a holding disc or cover plate 21. Cover plate 21 is a rigid disc-shaped member with a center hole, where an hour shaft passes there through, pin holes, where pins from quartz clock movement pass there through, and screw holes used to secure cover plate 21 to outer case 22. Holding disc 21 is disposed above quartz clock movement so that all pins on the clock movement pass through pin holes on holding disc 21. The outer diameter of holding disc 21 is fitted to the inner side of circular wall 37 with screws inserted through screw holes on holding disc 21 and threaded into long nuts on the bottom of outer case 22, to secure the holding disc 21 and quartz clock movement.

Wall clock 10 further comprises a day disc gear train 56 that drives day disc 26. Day disc gear train 56 comprises a gear wheel 62, a first drive assembly 57, and a second drive assembly 58.

First drive assembly 57 is depicted in FIG. 19. First drive assembly 57 comprises a 24-hour gear wheel 72 with a short catch 85 and a center hole 83, and a control switch wheel 71 with a first long cure aperture 81, a second long cure aperture 82, a center hole 79, and a notch 80. Control switch wheel 71 is coaxially and rotatably disposed above the 24-hour gear wheel 72, so that short catch 85 is placed within first long cure aperture 81. First drive assembly 57 further comprises a driven wheel 69 with radial teeth occupying about half of the circumference of the wheel on the outer diameter thereof and a short catch 75. Driven wheel 69 is coaxially and rotatably disposed above the control switch wheel 71, so that short catch 75 is placed within second long cure aperture 82. First drive assembly 57 further comprises a spring 70 that is coaxially disposed between driven wheel 69 and control switch wheel 71 to connect these wheels together. First drive assembly 57 further comprises a two-tooth wheel 68 that coaxially disposed above driven wheel 69 and secured to driven wheel 69. A lock ring holds first drive assembly 57 in place on the pin. Gear wheel 62 engages with driven wheel 69 and two-tooth wheel 68 engages gear ring 151 on day disc 26 at midnight to drive units disc 26.

First long cure aperture 81 allows the control switch wheel 71, when being driven by driven wheel 69, to rotate relative to 24-hour gear wheel 72 without rotating 24-hour gear wheel 72. Second long cure aperture 82 with short catch 75 of driven wheel 69 keeps control switch wheel 71 rotating, even when spring 70 may not have enough energy to support control switch wheel 71 causing it to jump down a lever of the switch called the first switch 47. Normally, spring 70 keeps driven wheel 69 rotating, whenever control switch wheel 71 is driven by 24-hour gear wheel 72, as well as allowing the 24-hour gear wheel 72 to drive control switch wheel 71 when driven wheel 69 is stopped, since the first tooth of the driven wheel 69 engages gear wheel 62 of day disc gear train 56. Whenever day disc gear train 56 starts to drive, spring 70 forces the driven wheel 69 against gear wheel 62. Further details will be explained below.

Second drive assembly 58 comprises a drive wheel 88 and a two-tooth wheel 87 coaxially and rotatable disposed above and secured to drive wheel 88 for driving day disc 26. A lock ring 86 holds second drive assembly 58 in place on the pin. When first drive assembly 57 releases from gear wheel 72 after finishing a drive, and second drive assembly 58 engages gear wheel 72 to drive day disc 26 for correcting the day of the week after battery replacement.

The outer surface of the closed end of cylindrical-shaped member of outer case 22 further comprises a battery house 42 and a housing battery cover 198 as seen in FIG. 46.

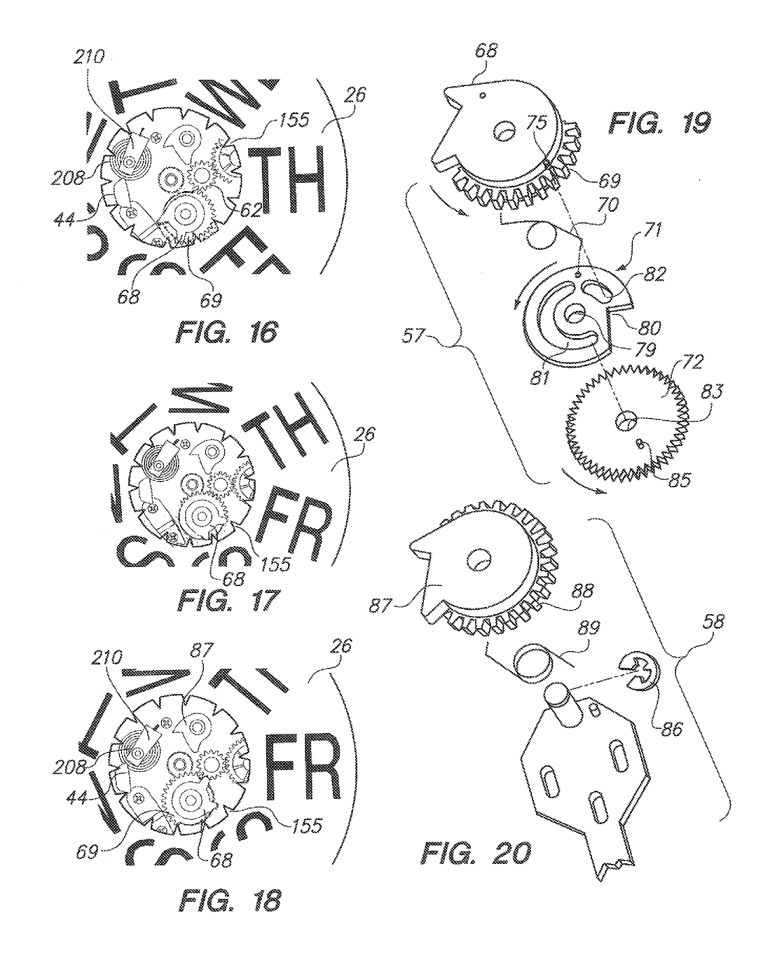

Wall clock 10 further comprises a drive motor 46 for driving day disc gear train 56, a first switch 47, and a second switch 48. First switch 47 is mounted on the holding disc 21, so that the lever of first switch 47 is engaged with the outer side of control switch wheel 71. At midnight, the lever of first switch 47 jumps into notch 80 on the control switch wheel 71, which is driven by the 24-hour gear wheel 72, to turn first switch 47 ON, causing drive motor 46 to start to drive day disc gear train 56. A pair of gear wheels of day disc gear train 56 has a top gear wheel 54 engaged with a gear ring 151 on the rear surface of units disc 28 to drive units disc 28. While units disc 28 is rotating, this causes the second switch 48 to turn ON, prior to first switch 47 switching OFF. While driven wheel 69 is driven by gear wheel 62 of day disc gear train 56, the lever of first switch 47 slides in notch 80, raising the outer side of the control switch wheel 71, causing first switch 47 to turn OFF. Day disc gear train 56 continuously drives day disc 26 until the last tooth of two-tooth wheel 68 has released gear wheel 62 as seen in FIGS. 16-18. A jumper 44, which is controlled by a spring 133, jumps into an interstice of day disc 26 to keep disc 26 in the correct position. Units disc 28 continuously rotates until the current day of the month appears in date window 14, and second switch 48 switches OFF.

Second switch 48 is mounted to the inner side of the outer case 22. The lever of second switch 48 is extended and forms a round end 31. The round end is entered into a notch 29 on units disc 28. Whenever units disc 28 rotates, round end 31 allows units disc 28 to rotate over and press down on round end 31, causing second switch 48 to switch ON and whenever round end 31 jumps into the notch 29 on the units disc 28, second switch 48 is switched OFF.

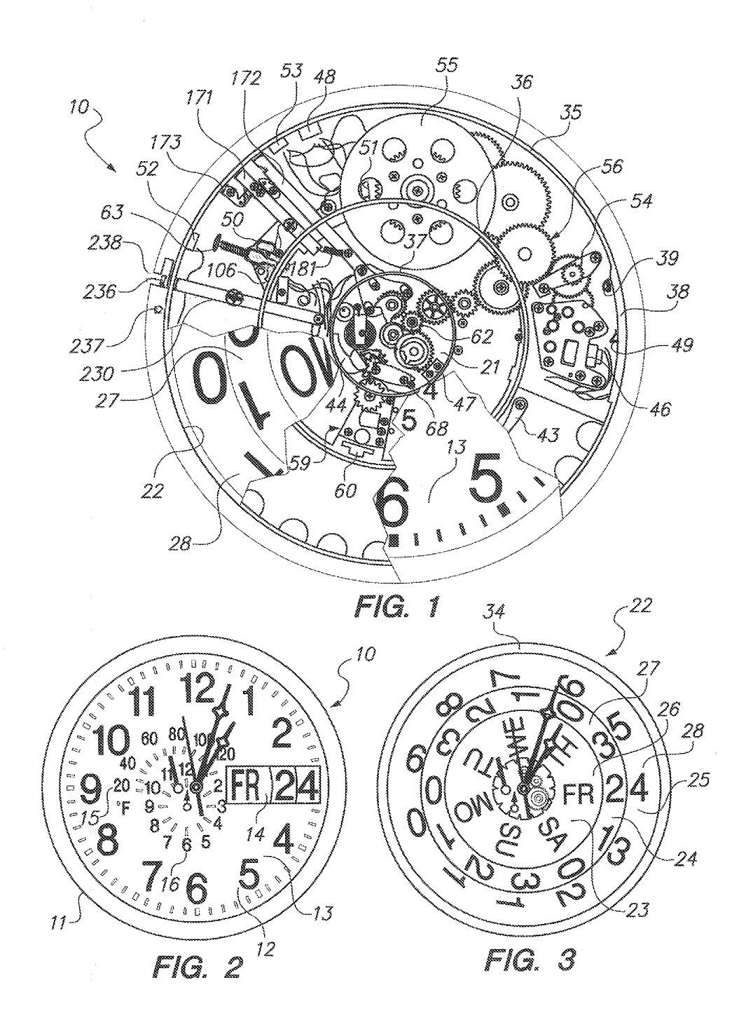

There are two number 1's on the units disc 28. The number 1 next to 0, called the first number 1, and the other number 1 next to 2, called the second number 1. Whenever the number 1 or 2 on the tens disc 27 and the first number 1 on the units disc 28, appear through the date window 14 at the same time (corresponding to days 11 and 21), the second number 1 on the units disc 28 will be passed. While the units disc 28 is rotating, one end of third movable pin 159 on the units disc 28 slides over the outer side of cam 163 on tens disc 27, causing the other end of the of third moveable 159 to actuate a switch called the third switch 49 ON, allowing the units disc 28 to rotate past the second number 1, so the number 2 appears through the date window 14. As stated above, the third movable pin 159 is free moving within the limit thereof. To avoid the third moveable pin 159 unexpectedly contacting the third switch 49, a bump 39 is mounted to the inner side of the outer case 22, and located before the third switch 49 as seen in FIG. 1.

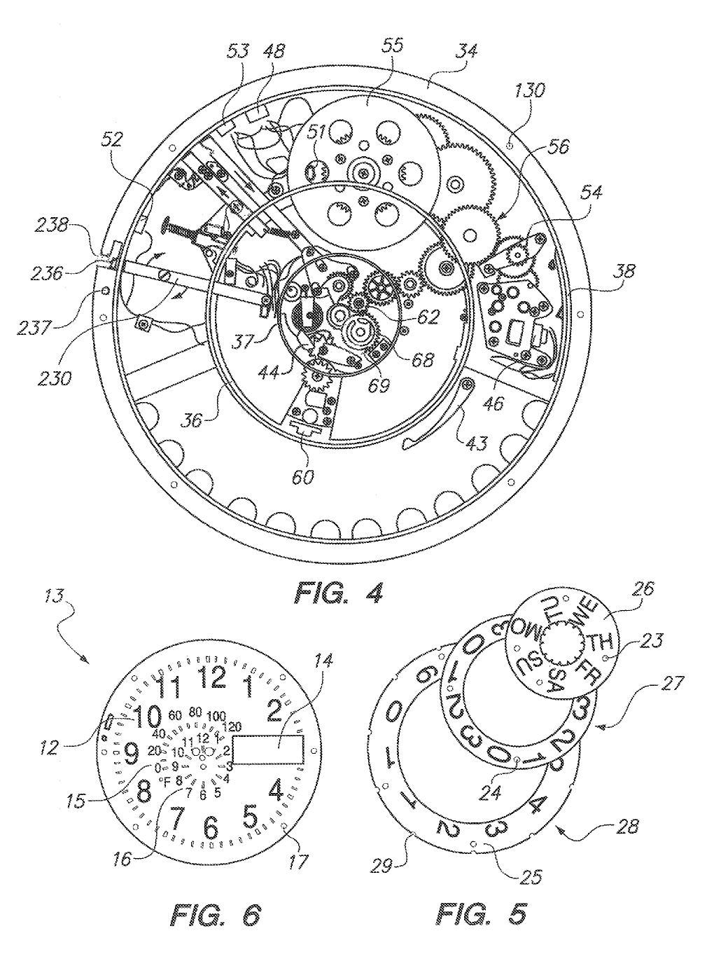

When the number 0, 1, or 2 on tens disc 27, is displayed with the number 9 on the units disc 28 at the same time (corresponding to days 09, 19 and 29), the tens disc 27 will be driven. While the units disc is rotating, one end of the first movable pin 157 on the units disc 28 slides over a side of a long cam 38, which is formed to the inner side of the ring 35, causing the other end of first movable pin 157 to engage with the catch 164 on tens disc 27, and drive the tens disc 27 to the next unit thereof. First movable pin 157 is released after it has passed the long cam 38, and before the units disc stops. A jumper 43 (see FIG. 4), which is controlled by a spring, jumps into the notch 154 on the ring 152, to keep the tens disc in correct position thereof.

When the number 3 on the tens disc 27 is displayed with the first number I on the units disc 28 at the same time (corresponding to day 31), the tens disc 27 will be driven. While the units disc 28 is rotating, one end of the second movable pin 158 on the units disc 28 slides over the side of the long cam 38, causing the other end of second movable pin 158 to engage with the catch 165 on the tens disc 27, and drive the tens disc 27 to the next unit thereof. Second movable pin 158 is released after it has passed the long cam 38.

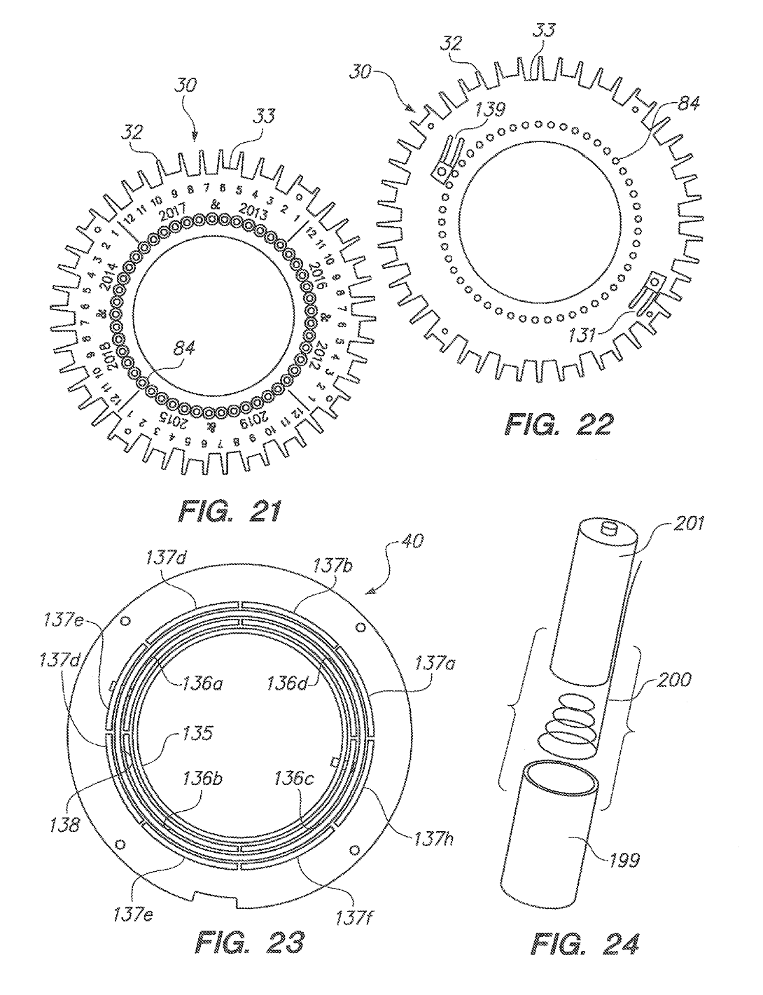

Wall clock 10 further comprises a calendar cam 30 as depicted in FIG. 21. Calendar cam 30 is a rigid disc-shaped member with forty-eight teeth 32 and forty eight interstices 33 positioned radially along the outer circumference. The depths of the interstices 33 are various, which depend on the lengths of months along a four year scale accounting for a leap years. The shallowest depths of the interstices 33 called the first depths for controlling the corrections of the ends of the months having 28 days. The second depth is for the month having 29 days. The third depth is for the months having 30 days, and the deepest depth is for the months having 31 days.

Calendar cam 30 is rotatably disposed above the bottom of outer case 22. The inner side of the cam 30 is rotatably fitted to the outer side of the circular wall 37. A ring 211 is secured to the inner side of the front surface of the calendar cam 30, so that the top side of the ring 211 rotatably engages with the rear surface of a cam cover disc 40, to keep the cam is rotatable in the position thereof. See FIGS. 34 and 35.

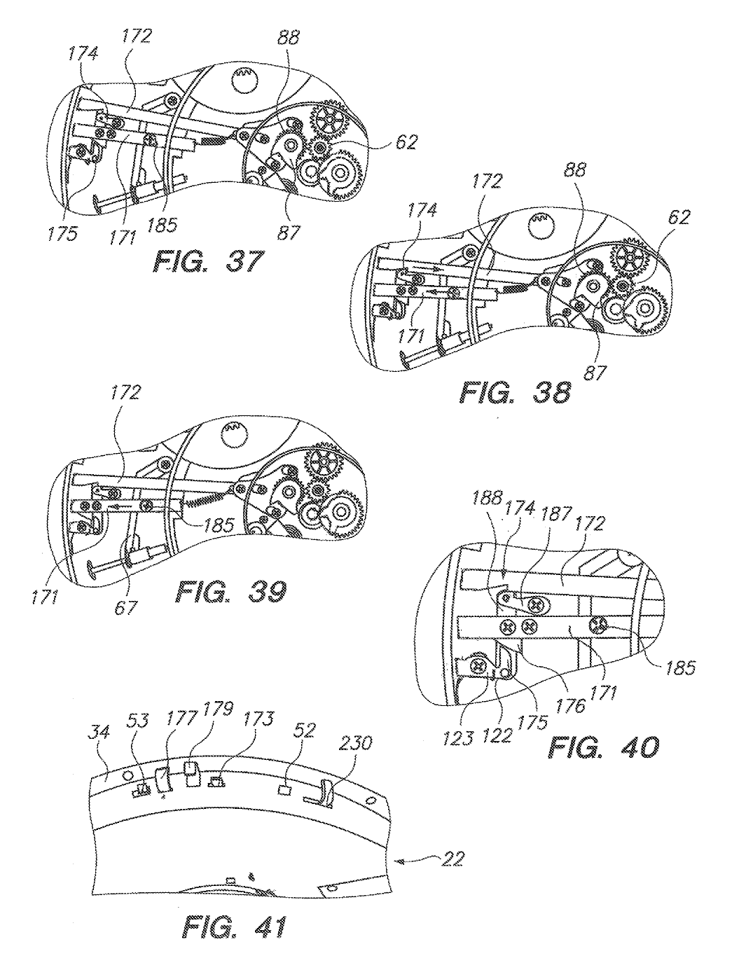

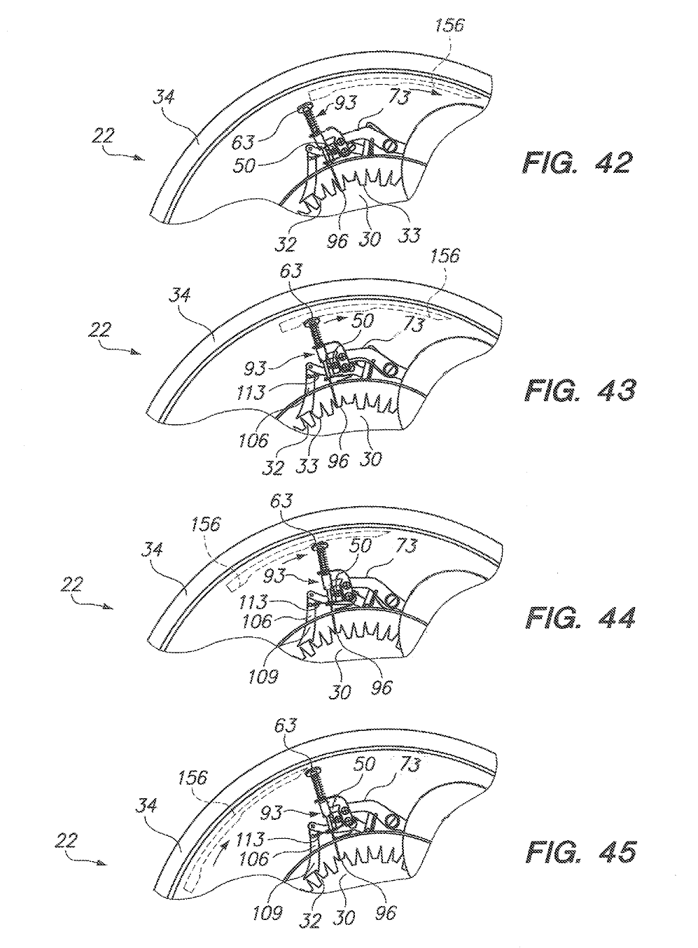

Wall clock 10 further comprises a control switch assembly 64 as depicted in FIGS. 31-45. Control switch assembly 64 comprises a cam drive assembly 65 and a control arm portion 67, which carries a switch called the fourth switch 50 with a moveable pin 93 thereon.

Cam drive assembly 65 includes a control drive portion 119, which has one end rotatably mounted to a post mounted to the bottom of the case 22. A finger 112 extends from this end of the control drive portion 119 to cooperate with a long cam 98 on a control disc 55 to rotate the control drive portion 119 to move a cam driver 106 for rotating the calendar cam 30. Between the control drive portion 119 and cam driver 106 are a connector arm 121 and a bell crank 120. Bell crank 120 is rotatably mounted to a post mounted to the bottom of the outer case 22, with a spring 114 thereon. The spring 114 helps bell crank 120 to return to its original position after completing a cam drive operation.

Connector arm 121 has one end 117 rotatably connected to one end 122 of the control drive portion 119 by a rivet. The other end 118 of connector arm 121 is rotatably connected to one end of the bell crank 120 by another rivet. The cam driver 106 has one end 116 rotatably connected to the other end 115 of the bell crank 120 by another rivet. A small spring 113 is connected to both of the cam driver 106 and the bell crank 120 together, to force the other end 109 of the cam driver 106 to engage with the teeth 32 of the calendar cam 30.

Control arm portion 67 includes a switch called the fourth switch 50 with a movable pin 93 thereon. Moveable pin 93 has a round bump 94 and is movably mounted between a pair of brackets to engage with the fourth switch 50. Whenever movable pin 93 is moved or slid, it actuates the fourth switch 50. A small wheel or head 63 is mounted to the top end of movable pin 93 to cooperate with a three step cam 156 on units disc 28 to control the fourth switch 50 as depicted in FIGS. 42-45). Head 63 also keeps a coil spring 66 in place, which provides outward radial pressure on movable pin 93 to insure proper engagement. Coil spring 66 helps pin 93 to return to the original position thereof, after the three step cam 156 has passed head 63.

Control arm portion 67 includes a control arm 73 with one end coaxially and rotatably mounted to control drive portion 119. This end of the control arm 73 is extended to form a finger 107. When finger 107 engages the long cam 98, the control arm 73 is rotated, lifting the other end 96 of the control arm portion 67 out of the interstice 33 of the calendar cam 30 (see FIG. 35), to allow the cam driver 106, to rotate the cam 30. A spring 97 is connected to the control arm portion 67, to force the end 96 of the control arm portion 67 to turn back and engage with the next bottom of the interstice 33, when the control arm portion is released.

Control disc 55 is a two concentric disc assembly where one disc is smaller with gear teeth on the outer circumference thereof and the other disc is larger with a long cam 98 on the adjacent surface to the smaller gear as depicted inn FIGS. 29 and 30. Control disc 55 is driven by day disc gear train 56 to make one revolution per month.

The end-of-the-month day-correction mechanism of the units disc causes the units disc 28 to rotate up to three additional display numbers each month. To avoid an incorrect date display, a fifth switch 51 is provided. A lever of the fifth switch 51 is located to cooperate with long cam 98 on the control disc 55 to actuate fifth switch 51 ON or OFF, and fifth switch 51 is wired in series with fourth switch 50, and a drive motor. Normally, fifth switch is OFF and the circuit electrical line is disconnected. Fifth switch 51 is only ON during the last four days of per month (days 28, 29, 30, and 31). During these days, the long cam 98 on the control disc 55 engages the lever of the switch 51, causing switch 51 to turn ON.

FIGS. 42-45 depict the control processes of the end-of-the-month correction mechanism. In FIG. 42, the current month has 31 days, so no correction is necessary. Three step cam 156 on the units disc 28 will freely pass head 63 on the top end of the movable pin 93 without contacting or actuating the fourth switch 50. This is because the depth of the interstice 33 is sufficiently deep that movable pin 93 and head 63 will be in the fully lowered position.

In FIG. 43, the current month has 30 days. This means the end 96 of the control arm portion 67 is engaged with the bottom of the interstice 33 of the cam 30, corresponding to a month having 30 days. Thus, the control arm portion 67 and movable pin 93 mounted thereon are rotated higher one increment. Thus, while the units disc 28 is rotating to pass the 30th day of the month, and before the units disc was stopped at the 31st day of the month, the first step or highest step of the three step cam 156 engages head 63 of the pin 93, causing the fourth switch 50 to turn ON. Since the fifth switch 51 is already in ON position, the units disc 28 continuously rotates, causing the second switch 48 to turn ON. Then the fourth switch 50 is turned OFF when the three step cam has passed head 63. This allows the units disc 28 to rotate one additional display number to pass the 31st day and to indicate the first day of the next month.

In FIG. 44, the current month has 29 days. This means the end 96 of the control arm portion 67 is engaged with the bottom of the next shallower interstice, corresponding to a month having 29 days. This mean the control arm portion 67 is rotated to the second highest increment. Thus, while the units disc 28 is rotating to pass the 29th day, and before the units disc is stopped at the 30th day, the second step of three step cam 156 engages head 63 of the movable pin 93, causing the switch 50 to turn ON. This allows the units disc 28 to rotate two additional display numbers to pass the 30th and 31st days, to indicate the first day of the next month.

In FIG. 45, the current month has 28 days. This means the control arm portion 67 is engaged with the bottom of the shallowest interstice of the calendar cam 30, corresponding to a month having 28 days. This means, the control arm portion 67 is raised to the highest increment. Thus, when the units disc 28 is rotating to pass the 28th day, and before the units disc is stopped at the 29th day, the third step or lowest step of three step cam 156 engages head 63 of the movable pin 93, causing the fourth switch 50 to turn ON, allowing units disc 28 to rotate three additional display numbers to pass the 29th, 30th, and 31st days, to indicate the first day of the next month.

While units disc 28 is rotating to pass the 31st day, to indicate the first day of the next month, long cam 98 on control disc 55 engages finger 107 of the control arm 73, causing the control arm portion 67 to lift the other end 96 out of interstice 33 of calendar cam 30. Then long cam 98 engages finger 112 of control drive portion 119, causing cam driver 106 to push on tooth 32 of calendar cam 30 to advance calendar cam 30 by one tooth. Calendar cam 30 is rectified by a jumper 219 jumping into the interstice of the calendar cam 30.

When long cam 98 on control disc 55 has passed fingers 107 and 112, control drive portion 119 returns to its original position and end 96 of the control arm portion 67 returns to its normal position and engages the bottom of the next interstice 33. This completes the end-of-the-month correction mechanism.

Wall clock 10 further comprises a gear train 59 for driving a month indicator hand 18 as depicted in FIGS. 27 and 28. Gear train for driving a month indicator hand 18 has a first gear 60 that engages teeth 32 of the calendar cam 30 and a last gear 61. Once a month, calendar cam 30 is rotatably advanced one tooth, thus first gear 60 and the last gear 61 are also is driven one tooth. Last gear 61 has twelve teeth and a center hole, with a shaft 214 rigidly mounted there through, which is rotatably mounted to cover plate 21. A bracket 216 is mounted to the cover plate 21 to secure gear wheel 61 and shaft 214 in place for rotation. A rotatably mounted, spring-loaded foot 215 is mounted on cover plate 21, engaging the last gear wheel 61 to maintain the gear wheel 61 in the correct position between month changes. A month indicator hand 18 is mounted to the top of the shaft 214 after the clock dial 13 is assembled.

After battery sets are replaced, the indicated time should be adjusted for accuracy. A stem wheel 195 on the back of wall clock is used for this.

The indicated day, date, and month are adjusted as follows. Day disc gear train 56 has a wheel connector bar 172 inserted through a hole in the side of outer case 22, then through another hole in the side of circular wall 36, and then rotatably connected to a wheel holding plate 182, by a two step screw 183, which is inserted through a hole in the wheel holding plate 182, driven into a bore, and threaded into the end of the wheel connector bar 172. The other end of the wheel connector bar 172 protrudes through outer case 22 to form a square end 177. A spring 181 is connected to the wheel connector bar 172 to force wheel connector bar 172 back after an auto lock 174 is released.

Wheel holding plate 182 has three long apertures thereon, and two step screws are inserted through these apertures, then driven into bores and threaded into the holding disc 21, and allowing the wheel holding plate 182 to move within the limit thereof. An axle 95 is mounted to the wheel holding plate 182, and rotatably fixed inside the center hole of the second drive assembly 58, and a lock ring 86 is mounted to the top of axle 95.

Auto lock 174 comprises a lock portion 187, which is a rigid member oblong member. Lock portion 187 has one end with a screw hole through which it is mounted by a two step screw inserted there through and driven into a long nut mounted to the bottom of the outer case 22. The other end of lock portion 187 is rotatably connected to one end of a connector bar 188 by a rivet. The other end of connector bar 188 is rotatably connected to one end of the lock release portion 123. The other end 173 of lock release portion 123 is inserted through a hole in the side of outer case 22 for controlling the lock release portion 123 by hand. A spring 124 is inserted over a long nut mounted on the bottom of outer case 22 where a two step screw 186 is inserted through a hole in the lock release portion 123 then threaded into the long nut to rotatably mount the lock release portion 123. Spring 124 has one end connected to the lock release portion 123 and the other end is engaged with the side of the outer case 22 for forcing the lock portion 187 to lock the wheel connector bar 172, also to force the lock release portion 123 to turn back after the end 173 is pushed to release auto lock 174.

When the indicated day and date need to be adjusted, the square end 177 of the wheel connector bar 172 is pushed by hand, to engage the drive wheel 88 with the gear wheel 62 of the gear train 56 where the auto lock 174 automatically locks wheel connector bar 172 and turns a switch, called the sixth switch 53, ON, the gear train starts to drive, then turns OFF about two seconds later (at this time, the second switch 48 is ON), so the units disc 28 rotates until a day and date change is completed. The second switch 48 is automatically turned OFF. The auto lock 174 is released by pushing the lock release handle 173 located outer side of the outer case 22. If the indicated day and date indicating need to be adjusted by more than one day, leave the switch 53 ON until the current day of the week completely appears through the date window 14, release the auto lock 174, and keep switch 53 ON until the current day of the month begins to appear through the date window 14, then turn switch 53 OFF (the second switch 48 is ON), so the units disc 28 still rotates until the current date completely appears through the date window 14, then the second switch 48 is turned OFF.

When auto lock 174 is released, a two-tooth wheel 87 stops rotating. To avoid locking the day of the week disc 26, disc 26 is driven by another two-tooth wheel 68 at midnight. A spring 89 is coaxially disposed between the wheel holding plate 182 and the drive wheel 88. One end of spring 89 is connected to drive wheel 88 and the other end of spring 89 is free moving. A catch 90 is arranged and mounted to wheel holding plate 182. The catch 90 is cooperates with the free moving end of the spring 89 to prevent the two-tooth wheel 87 from locking the day of the week disc 26. When two-tooth wheel 87 is stopped at the problem location, spring 89 forces two-tooth wheel 87 to rotate backward when auto lock 174 is released. Normally, the free moving end of the spring 89 passes the catch 90, while two-tooth wheel 87 is rotating to indicate the day of the week.

The indicated month is adjusted as follows. The rear surface of calendar cam 30 has month/year figures of forty-eight months for four years included the leap year. Each month figure has a small hole 84, threaded through calendar cam 30 for driving calendar cam 30 by hand. Windows 196 and 197 are made through the bottom of outer case 22. The current month and year from the figures on the rear of calendar cam 30 appear through windows 196 and 197. A control bar 171 is inserted through a hole in the side of outer case 22, and then through another hole in the side of circular wall 36. A long body screw 185 is driven through a bore threaded into the control bar 171, so that when control bar 171 is pulled out, the body of the screw 185 engages with the control arm portion 67 to lift end 96 of the control arm portion 67 out of the interstice 33 of calendar cam 30. Lock release portion 123 has one end 175 engaged with a catch 111 attached to control bar 171 and when the control bare 171 is pulled out completely, the end 175 of the lock release portion 123 jumps over a catch 111 to lock onto control bar 171. Catch 111 also limits the control bar 171 from moving out too much. The end 179 of the control bar 171 stays outside of outer case 22 and has a square end 179 to allow control bar 171 to be pulled out by hand. The spring 181 has one end connected to the end of control bar 171 to force it back when released. Note: the lock release portion 123 can release two auto locks at the same time.

After control bar 171 is pulled out and locked, turn the clock over to face the back of the clock, use a toothpick, pen, small nail or similar to insert into one of holes 84, made through the calendar cam 30 to hand drive calendar cam 30 clockwise until the current month and year appears appear through windows 196 and 197. Then, release the lock.

Wall clock 10 further comprises a temperature device 208 that has one end secured to an axle 108 located in the center thereof and the other end is inserted through a hole 209 made into the holding portion 210 which is formed on the holding disc 21. Axle 108 is rotatably inserted through hole 207, and the temperature indicator hand 17 is mounted to the end 109 of the axle 108 for indicating current temperature, after clock dial 13 is assembled.

Wall clock 10 is operated by two battery sets and designed to be replaced every four years. That is the time required for the calendar cam 30 to make one complete revolution. Referring to FIG. 22, the front surface of the calendar cam 30 includes a pair of brushes 131, 139. Brush 131 is for the drive motor battery set and brush 139 is for quartz clock movement battery set. Brushes 131 and 139 contact respective pairs of conductor lines 206 and 212, mounted to the rear surface of cam cover disc 40. One line per pair is a continuous connection and the other line is divided into multiple segments, the length of each segment depends upon how the battery set can reliably supply power before losing charge. For example, one battery 201 can provide power for quartz clock movement to work for one year, so four batteries will provide power in four year operation. The divided segments are denoted by 212 and each segment is connected to a battery 201. The continuous connections are connected to quartz clock movement. Brush 139 connects the segments of the conductor lines to the continuous line to provide power to quartz clock movement. Power source is four AA batteries 201 for quartz clock movement and eight AA batteries 201 for the drive motor. Thus, one line of the couple lines 206 for the drive motor is divided eight segments.

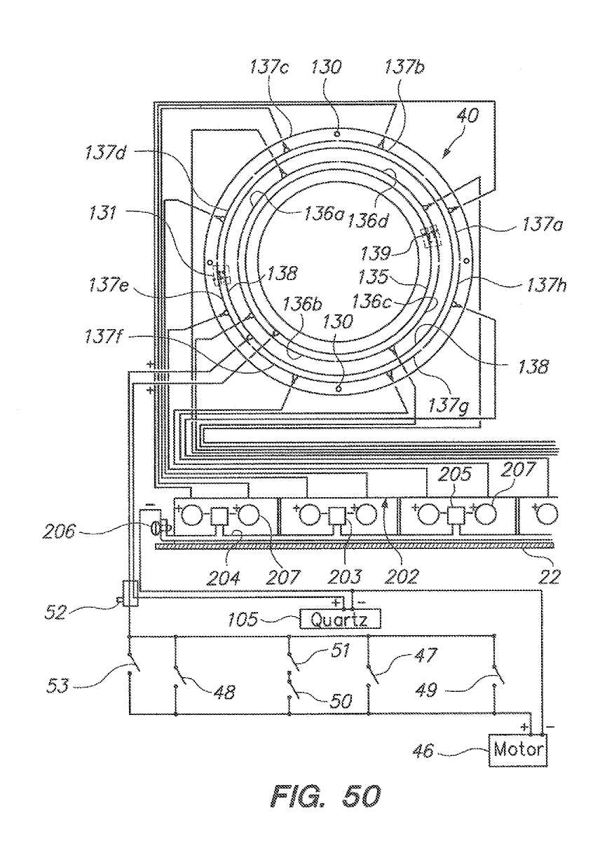

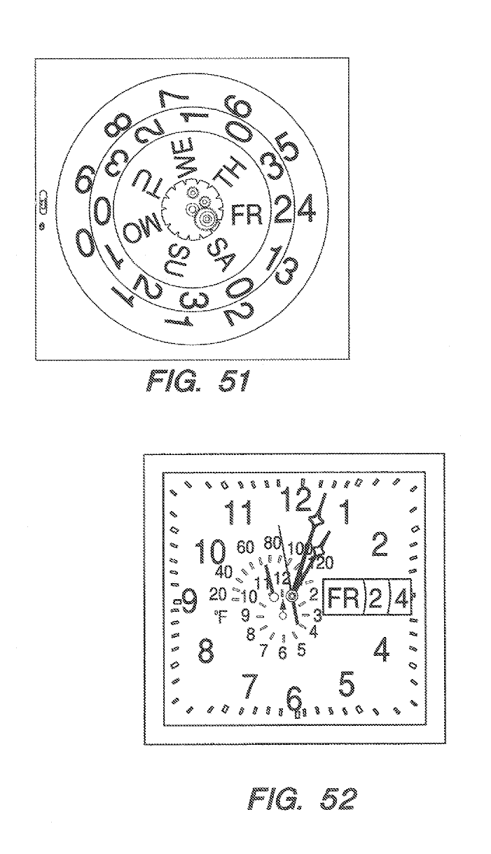

FIGS. 46-50 depict electrical components and a circuit diagram, showing per battery 201 is secured within a plastic housing 199, with a springs 200 in its lower end. Positive lines are connected to the positive connector of each battery 201. Negative lines are connected to spring 200 beneath each battery. The positive lines that extends from the battery set to power motor 46 include lines 137a, 137b, 137c, 137d, 137e, 137f, 137g, and 137h. One of these lines is connected to a respective one of the eight conductor segments. A positive return line 138 is connected to a main switch 52, then on to the positive terminal of the drive motor 46. Brush 131 connects one segment leading to line 137e to the continuous line interconnected to line 138. In that manner, the battery 201 connected to line 138e is interconnected to one terminal of the drive motor 46, through the various switches said above. All of the negative terminals of the batteries 201 are connected together, through negative line 134, which interconnected both to drive motor 46, and to the quartz clock movement.

Wall clock 10 further comprises a low battery signal device depicted in FIGS. 48 and 49. Low battery signal device comprises: a low battery signal flag 239 and a flag control bar 230. Flag control bar 230 is inserted through a long aperture on the wall side of the outer case 22, and through another long aperture on the wall side of the circular wall 36. The outer end 236 of flag control bar 230 is bent up 90 degree and pushed into the long aperture 238 on the flange 34 of the outer case 22. The other end of flag control bar 230 carries a screw 232, the body of this screw 232 is inserted through a long aperture 235 made through the cover disc 40. Flag control bar 230 is rotatably mounted to a post 234 secured to the bottom of the outer case 22 by a two-step screw 231. An axle 237 is mounted to the topside of flange 34 of outer case 22. Clock dial 13 has a hole 242 that axle 237 goes through and a long aperture 243 that the moveable end 236 of control bar 230 goes through. The wall side of the retainer ring 19 has long aperture 256 that the sign LOW BATTERY goes through; the bottom side of the retainer ring 19 has a hole 254 and a long aperture 255. Retainer ring 19 is disposed over the clock dial 13 so as the axis 237 is inserted through the hole 254 and the long aperture 255 is passed through end 236 and fits to the long aperture 242 on the clock dial 13. One end of the low battery signal flag 239 has a hole 240 and a notch 244, the other end of the low battery signal flag 239 carries the words LOW BATTERY. Flag 239 is disposed over the bottom side of the retainer ring 19, so as the axis 237 is inside the hole 240. A lock ring 245 is mounted to axle 237. End 236 of flag control bar 230 is moved into the notch 244 to keep the flag up. A spring 241 is mounted to the flag 239 to pull down the flag when the end 236 of flag control bar 230 is moved out of the notch 244. A screw 233 is driven through a threaded hole on the cam 30. While the cam 30 is rotating, the body of the screw 233 pushes and passes the body of the screw 232 mounted on the end of control flag bar 230, causing the other end 236 of flag control bar 230 to move out of the notch 244 causing the sign LOW BATTERY to fall down and appear over clock dial 13. To reset the flag up, the elbow of the flag control bar 230 located at the outer side of outer case 22 is pulled counter-clockwise. An optional lower cost wall clock has the same features as described above clock, but the batteries are replaced per year. This clock has a small battery house, holding only three batteries, one battery for quartz clock movement, and two remaining batteries for the drive motor. However, if the clock is designed for one year battery replacement, four screws are needed to mount on the calendar cam.

1. A wall clock 10 comprising:
an outer case that is a rigid cylindrical-shaped, cuboid-shaped, or rectangular cuboid-shaped member with a closed end, an open end, and a ring [35] on the inner diameter of said open end;
said closed end of said outer case has a front surface that is the interior side and a rear surface that is the exterior side of said closed end;
a first circular wall [36] and second circular wall [37] protruding at a right angles from said inner surface of said closed end of said outer case, where said first and second circular walls are concentric with the center longitudinal axis of said outer case;
a day disc [26], a tens disc [27], and a units disc [28] where each is a rigid disc-shaped members with a front surface, a rear surface, and a hole in the center;
said day disc has a ring [153] on its rear surface and is rotatably disposed above said second circular wall so that the outer diameter of said ring 153 forms a slip fit or clearance fit with the inner diameter of said second circular wall;
said tens disc has a ring [152] on its rear surface and is rotatably disposed above said first circular wall so that the inner diameter of said ring 152 forms a slip fit or clearance fit with the outer diameter of said first circular wall;
said units disc is rotateably disposed above said ring 35 and engages with said front surface of said outer case 22;
said front surface of said day disc has a visual depiction of the seven days of the week equally spaced around the outer circumference of said day disc and seven small bumps [23] on said front surface of said day disc, one placed between each visual depiction of a day of the week;
said front surface of said tens disc has a visual depiction of three sets of the number sequence 0, 1, 2, 3 equally spaced around the full outer circumference of said tens disc and twelve small bumps [24] on said front surface of said tens disc 27, one placed between each number;
said front surface of said units disc 28 has a visual depiction of the number sequence 0, 1, 1, 2, 3, 4, 5, 6, 7, 8, 9 equally spaced around the full outer circumference of said units disc and eleven small bumps [25] on said front surface of said units disc, one placed between each number;
a clock dial 13 that is a rigid disc-shaped member with a front surface, a rear surface, a date window [14], a temperature hole [73], and a month hole [74];
said front surface and said clock dial includes a temperature scale depiction [15] and an hour scale depiction [12];
a month indicator hand [18], a second hand, a minute hand, and an hour hand that are rigid oblong members with one end attached to a drive mechanism and the other end referencing a point on their respective scale depictions;
said rear surface of said unit disc includes a three step cam [156] that is a raised area on said rear surface of said units disc running along the outer circumference of said units disc that is in the form of three steps with rounded increments between each step;
a calendar cam [30] that is a rigid disc-shaped member with forty-eight teeth and forty eight interstices 33 positioned radially along its outer circumference and is rotatably disposed above said front surface of said outer case 22 with inner diameter of said calendar cam rotatably fitted to the outer diameter of said second circular wall;
said units disc is driven by a drive motor that drives said units disc one revolution per month and includes and end-of-the-month control process to cause said units disc to rotate through zero to three additional display numbers on said visual depiction of the number sequence 0, 1, 1, 2, 3, 4, 5, 6, 7, 8, 9, wherein said end-of-the-month control process occurs as follows,
if the current month has 31 days, said three step cam does not contact said calendar cam during said one revolution with zero additional of said units disc,
if the current month has 30 days, said three step cam contacts said calendar cam during said one revolution at its upper most step, causing additional rotation through one display number on said visual depiction of the number sequence 0, 1, 1, 2, 3, 4, 5, 6, 7, 8, 9 on said units disc,
if the current month has 29 days, said three step cam contacts said calendar cam during said one revolution at its middle step, causing additional rotation through two display numbers on said visual depiction of the number sequence 0, 1, 1, 2, 3, 4, 5, 6, 7, 8, 9 on said units disc,
if the current month has 28 days, said three step cam contacts said calendar cam at its lower most step, causing additional rotation through three display numbers on said visual depiction of the number sequence 0, 1, 1, 2, 3, 4, 5, 6, 7, 8, 9 on said units disc;
a day disc gear train [56] that drives said day disc that; and
a gear train [59] for driving said month indicator hand.
